(19) United States
(12) Patent Application Publication
(10) Pub. No.: US 2008/0062968 A1
(43) Pub. Date: Mar. 13, 2008

(54) Mobile radio terminal and mobile telephone

(75) Inventors: Junichi Takahashi, Hamura-shi (JP); Takeshi Nagai, Tokorozawa-shi (JP); Tatsuya Zettsu, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/796,949

(22) Filed: Apr. 30, 2007

(30) Foreign Application Priority Data
Sep. 8, 2006 (JP) 2006-244737

(51) Int. Cl. H04L 12/66

(52) U.S. Cl. 370/352

(57) ABSTRACT

Upon making a request for start of position registration for IP-telephone-terminal of an incoming-call-side, IP-telephone-terminal of an outgoing-call-side notifies the IP-telephone-terminal of identification information of the own terminal. If the user makes a request for terminal of the outgoing call before establishment of an IP-communication-link, the IP-telephone-terminal notifies the IP-telephone-terminal of the termination request indicating the termination of the outgoing call, together with the identification information of the IP-telephone-terminal of the outgoing call side. When the IP-telephone-terminal of the incoming call side receives the notification of the termination request, the IP-telephone-terminal disconnects the IP-communication-link established with the radio base station and becomes in the standby status if there is a single outgoing call terminal, or maintains the IP-communication-link established with the radio base station if there are a plurality of outgoing call terminals and the IP-telephone-terminal does not accept the terminal request from all the outgoing call terminals.

### CROSS-REFERENCE TO RELATED APPLICATIONS

This application is based upon and claims the benefit of priority from prior Japanese Patent Application No. 2006-244737, filed Sep. 8, 2006, the entire contents of which are incorporated herein by reference.

### BACKGROUND OF THE INVENTION

1. Field of the Invention

The present invention relates to a mobile radio terminal and a mobile telephone capable of speech communications based on IP (Internet Protocol) communications in a mobile communication network.

2. Description of the Related Art

Recently, development of a mobile radio terminal capable of accessing an IP network through a cellular telephone packet network has been in progress. The mobile radio terminal functions as an IP telephone capable of executing call control using a protocol such as SIP (Session Initiation Protocol) through the IP network. Since such an IP telephone uses the cellular telephone packet network for the access to the IP network, full-time connection is considered difficult.

As a communication system suitable for such an environment, the following communication system is conceived. In response to a call from an IP telephone of the outgoing call side (hereafter referred to as outgoing call terminal), an SIP server in the IP network urges an IP telephone of the incoming call side (hereafter referred to as incoming call terminal) to access the IP network in steps other than a protocol used for the call control, and the incoming call terminal executes position registration for a position management server inside the IP network after accessing the IP network and starts the call control with the outgoing call terminal.

In such a communication system, however, the request to access the IP network for the incoming call terminal cannot be made until the position registration of the outgoing call terminal is completed, call is made and the SIP server confirms the counterpart terminal information. In other words, the position registration of the incoming call terminal is executed after completion of the position registration of the outgoing call terminal.

In a case where the outgoing call terminal uses the SIP in controlling call process, the outgoing call terminal can cancel the outgoing call by sending a CANCEL message if the same processing as that at a general access to the IP network can be made during a period in which the outgoing call terminal makes an outgoing call with the INVITE message and the incoming call terminal completes the position registration and sends back a response.

However, if the outgoing call terminal cancels the outgoing call after the incoming call terminal has established the IP communication link and executed the position registration and before the incoming call terminal receives the INVITE message, the outgoing call terminal must notify the incoming call terminal that the outgoing call terminal has received the INVITE message, become in the incoming status and then canceled the outgoing call. For this reason, there is a problem that the incoming call terminal does not become in the incoming status, cannot disconnect the IP communication link and keeps maintaining the IP communication link.

The other prior art is a communication system in which when the SIP servers and a plurality of IP telephones are connected to one another, the SIP server recognizes the status of the IP telephones with presence information managed by a presence server and terminal information of the IP telephones (cf., for example, JP-A No. 2005-318503 (KOKAI)). In this communication system, the status of the IP telephones are recognized with the terminal information alone even if there is no presence server.

According to this technique, too, however, if the outgoing call terminal cancels the outgoing call after the incoming call terminal has established the IP communication link and before the incoming call terminal receives the INVITE message, the incoming call terminal is not notified that the outgoing call has been canceled. For this reason, there is the same reason as described above that the incoming call terminal keeps maintaining the IP communication link.

### BRIEF SUMMARY OF THE INVENTION

The present invention has been accomplished to solve the above-described problems. The object of the present invention is to provide a mobile radio terminal capable of disconnecting unnecessary IP communication links if an outgoing terminal cancels outgoing calls.

To achieve this object, an aspect of the present invention is a mobile radio terminal having a function of making radio communication with a radio base station accommodated in a mobile radio network and executing data communication based on IP communication. The terminal comprises a radio interface which communicates with the base station and receives identification information of a terminal of an outgoing call side from the radio base station, a link establishing unit which establishes an IP communication link via the radio base station if the radio interface receives the identification information of the terminal of the outgoing call side, an IP communication unit which makes data communication over the IP communication link, and a disconnection unit which disconnects the IP communication link if the radio interface receives again identification information which matches the identification information of a terminal of an outgoing call side, together with information of canceling the outgoing call before the IP communication unit makes the data communication.

According to the present invention, when the identification information of the outgoing call terminal is received from the radio base station, the IP communication link is established through the radio base station. After that, when the identification information matching the identification information of the outgoing call terminal is received again together with the information indicating the termination of the outgoing call before the data communication is executed over the IP communication link, the IP communication link is disconnected.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a configuration of a mobile communication system for a mobile radio terminal according to the present invention;

FIG. 2 is a block diagram showing a configuration of the mobile radio terminal shown in FIG. 1;

FIG. 3 is a sequence diagram showing operations of the mobile communication system shown in FIG. 1;

FIG. 4 is a sequence diagram showing operations of the mobile communication system shown in FIG. 1; and

FIG. 5 is a sequence diagram showing operations of the mobile communication system shown in FIG. 1.

### DETAILED DESCRIPTION OF THE INVENTION

An embodiment of the present invention will be described with reference to the accompanying drawings.

FIG. 1 schematically shows a configuration of a mobile communication system according to the embodiment of the present invention. A mobile communication network NW also comprises functions of an IP (Internet Protocol) network, and accommodates radio base stations BS and an SIP (Session Initiation Protocol) server 300. IP telephones 100, 200 are cellular telephones which establish radio communication with the radio base stations BS to make communication in the mobile communication network NW via the radio base stations BS. The IP telephones 100, 200 also comprise a function of making IP communication via the SIP server 300.

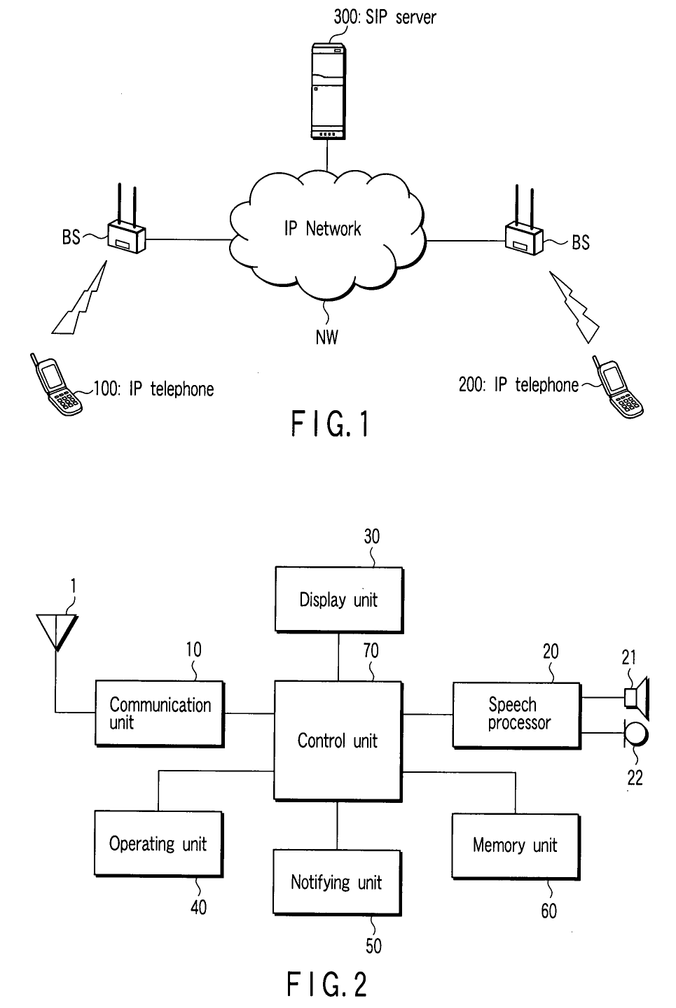

FIG. 2 shows a configuration of the IP telephones 100, 200. Each of the IP telephones 100, 200 comprises an antenna 1, a communication unit 10, a speech processor 20, a display unit 30, an operating unit 40, a notifying unit 50, a memory unit 60, and a control unit 70. The IP telephone comprises a camera shooting pictures (not shown) if IP telephone sends and receives picture data.

The antenna 1 receives radio signals transmitted from the radio base station BS, and sends radio signals from the IP telephone of the antenna 1 to the radio base station BS.

The communication unit 10 establishes radio communication with the radio base station BS via the antenna 1, and executes communication in the mobile communication network NW via the radio base station BS. More specifically, the communication unit 10 down-converts and demodulates the radio signal received by the antenna 1, obtains encoded speech data sent from the partner station, and outputs the encoded speech data to the speech processor 20 via the control unit 70. In addition, the communication unit 10 modulates the baseband signal with the encoded speech data supplied from the speech processor 20 via the control unit 70, generates a radio signal by up-converting the baseband signal, and sends the generated radio signal to the radio base station BS via the antenna 1. The communication unit 10 is able to selectively make general speech communication and IP communication.

The speech processor 20 regenerates a speech signal by decoding the encoded speech data demodulated by the communication unit 10, and outputs the speech signal by a built-in speaker 21. The speech sent from the partner station is thereby transmitted to the user. In addition, the speech processor 20 generates encoded speech data by encoding a speech signal input from a built-in microphone 22, and supplies the generated encoded speech data to the communication unit 10 via the control unit 70.

The display unit 30 is a display unit employing an LCD (Liquid Crystal Display), etc., which displays various kinds of visual information such as texts, pictures, etc. to the user. The operating unit 40 comprises a plurality of key switches to accept user's requests. The notifying unit 50 notifies the user of incoming calls by sounds.

The memory unit 60 stores control programs and control data of the control unit 70, data relating to the communication control received from the radio base station BS, and telephone directory data associated with telephone numbers, names, and picture data such as face pictures, and also stores mail data which have been sent and received.

The control unit 70 controls all the units of the IP telephone. For example, the control unit 70 comprises an incoming call controlling function of controlling the communication unit 10 to receive an incoming call signal from the radio base station BS in steps based on the SIP and, upon receiving the incoming call signal, controlling the display unit 30 and the notifying unit 50 to notify the user of occurrence of the incoming call, urging the communication unit 10 to transmit a signal responding to the incoming call by a response operation which the user makes by the operating unit 40, and establishing a speech communication link.

The control unit 70 also comprises an outgoing call controlling function of controlling the communication unit 10 to make an outgoing call to a telephone number designated by the user, in steps based on the SIP, in response to an outgoing call request which the user makes by employing the operating unit 40, and a communication controlling function of establishing a speech communication link on the basis of the outgoing call. In other words, the control unit 70 has the controlling functions to implement the determination of actions based on the SIP, generation of SIP messages, analysis of SIP messages, extraction of data from SIP messages, and sending and reception of SIP messages, in accordance with the SIP.

Besides the controlling functions to function as the IP telephone, the control unit 70 further comprises a controlling function of controlling the communication unit 10 to function as a cellular telephone making speech communication in a circuit switched network via the radio base station BS, and a browser function of making communication with the server in the Internet via the IP network, urging the display unit 30 to display the data provided by the server and allowing the user to browse the data.

The mobile communication network NW establishes communication with the IP telephones 100, 200 in the radio zone via the radio base stations BS, receives identification information from the IP telephones 100, 200, and manages position information. For this reason, in each of the IP telephones 100, 200, the control unit 70 controls the communication unit 10 to send the identification information stored in the memory unit 60 to the mobile communication network NW and register the positions of the IP telephone.

Next, operations of the IP telephones 100, 200 having the above configuration are described. In the following descriptions, IP telephone communication employing the SIP as the call control protocol is made between the IP telephone 100 and the IP telephone 200. In the IP telephone communication, not only speech, but pictures can be transmitted. For simple and clear descriptions, explanations about the details of communication between the IP telephones 100, 200 and the radio base stations BS close to the IP telephones are omitted.

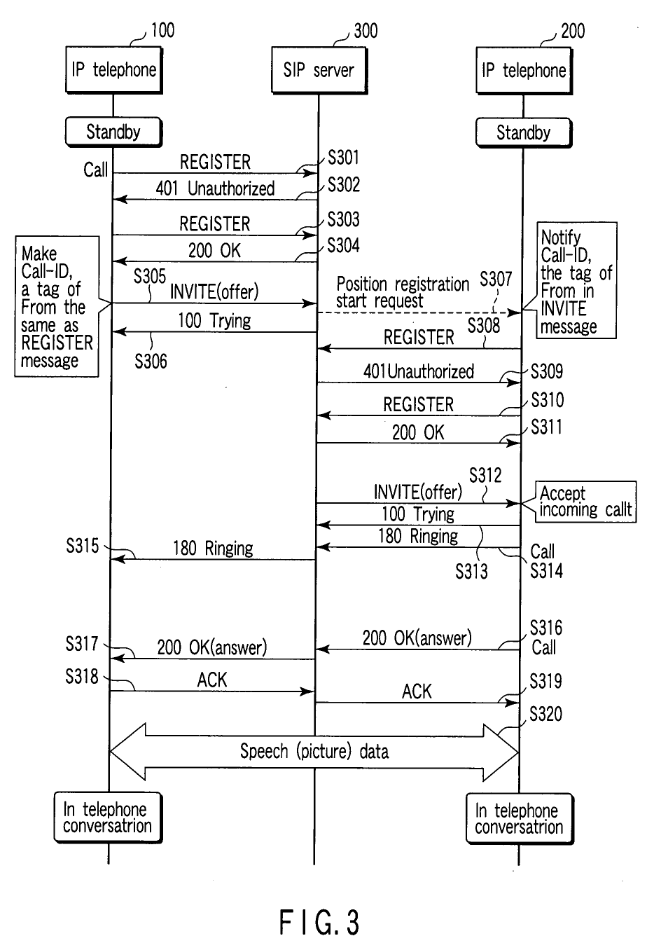

FIG. 3 is a sequence diagram of operations in a case where the IP telephone 100 is the outgoing side and the IP telephone 200 is the incoming side, illustrating the sequence from the outgoing call of the IP telephone 100 to the start of communication.

First, the IP telephone 100 and the IP telephone 200 in the standby status are not connected to the IP network and their existence is not recognized by the SIP server 300.

(Sequence S301) At the IP telephone 100, when the user operates the operating unit 40, inputs the dial number of the IP telephone 200 and makes an outgoing call request, the control unit 70 controls the communication unit 10 to connect to the packet network and send REGISTER request message to the SIP server 300 and start the position registration.

(Sequence S302) When the SIP server 300 receives the REGISTER request message, the SIP server 300 sends 401 Unauthorized message to the IP telephone 100 as a response (REGISTER response) to the REGISTER request message.

(Sequence S303) At the IP telephone 100, when the control unit 70 detects that the communication unit 10 has received the 401 Unauthorized message, the control unit 70 controls the communication unit 10 to send the REGISTER request message to the SIP server 300 again after server authentication.

(Sequence S304) When the SIP server 300 receives the REGISTER request message, the SIP server 300 sends 200 OK message to the IP telephone 100 as a response (REGISTER response) to the REGISTER request message after client authentication.

(Sequence S305) At the IP telephone 100, when the control unit 70 detects that the communication unit 10 has received the 200 OK message, the control unit 70 generates authentication information which includes identification information and codec ability information of the IP telephone 100 and identification information of the IP telephone 200 serving as the call destination (incoming terminal) as destination information, on the basis of the information stored in the memory unit 60.

The control unit 70 generates INVITE request message including these information items and controls the communication unit 10 to send the generated INVITE request message to the SIP server 300. Thus, the IP telephone 100 makes the call request for the SIP server 300 by sending the INVITE request message.

In the INVITE request message, the same Call-ID header field as the REGISTER request message sent in sequence S301, S303, and the tag parameter of From header field are described.

(Sequence S306) When the SIP server 300 receives the INVITE request message, the SIP server 300 sends 100 Trying message to the IP telephone 100 as a response (INVITE response) to the INVITE request message. At the IP telephone 100, when the control unit 70 detects that the communication unit 10 has received the 100 Trying message, the control unit 70 becomes in the standby status for notification (sequence S315, S317) from the SIP server 300.

(Sequence S307) The SIP server 300 specifies the incoming terminal as the IP telephone 200 on the basis of the destination information included in the INVITE request message, and specifies the radio base station BS with which the IP telephone 200 can make communication on the basis of the position registration information in the mobile communication network NW.

Then, the SIP server 300 makes the position registration request to urge the IP telephone 200 to connect to the IP network with an existing communication protocol other than the SIP by the communication means other than the IP network such as the circuit switched network, short-range communication means, etc. In the position registration request, the Call-ID header field and the tag parameter of From header field described in the INVITE request message received in sequence S305 are described.

(Sequence S308) At the IP telephone 200, when the control unit 70 detects that the communication unit 10 has received the position registration request, the control unit 70 controls the communication unit 10 to send the REGISTER request message to the SIP server 300.

(Sequence S309) When the SIP server 300 receives the REGISTER request message, the SIP server 300 sends the 401 Unauthorized message to the IP telephone 200 as a response (REGISTER response) to the REGISTER request message.

(Sequence S310) At the IP telephone 200, when the control unit 70 detects that the communication unit 10 has received the 401 Unauthorized message, the control unit 70 controls the communication unit 10 to send the REGISTER request message to the SIP server 300 again after server authentication.

(Sequence S311) When the SIP server 300 receives the REGISTER request message, the SIP server 300 sends the 200 OK message to the IP telephone 200 as a response (REGISTER response) to the REGISTER request message. The position registration concerning the IP communication at the IP telephone 200 is thereby completed. At this time, the IP telephone 200 establishes and maintains an IP communication link with the nearest radio base station BS.

(Sequence S312) The SIP server 300 sends the INVITE request message received in sequence S305 to the IP telephone terminal 200.

(Sequence S313) At the IP telephone 200, when the control unit 70 detects that the communication unit 10 has received the INVITE request message, the control unit 70 sends the 100 Trying message to the SIP server 300 as a response to the INVITE request message.

(Sequence S314) In addition, at the IP telephone 200, when the control unit 70 detects that the communication unit 10 has received the 100 Trying message, the control unit 70 displays the telephone number of the outgoing terminal (IP telephone 100) notified in sequence S312 on the display unit 30 and controls the notifying unit 50 to notify the user of the occurrence of the incoming call. In addition, the control unit 70 controls the communication unit 10 to send 180 Ringing message to the SIP server 300.

(Sequence S315) When the SIP server 300 receives the 180 Ringing message, the SIP server 300 sends the 180 Ringing message of the same contents as the received message to the IP telephone 100. At the IP telephone 100 receiving the 180 Ringing message, the control unit 70 controls the speech processor 20 to output a ringback tone from the speaker 21 and notify the user of calling the incoming terminal (IP telephone 200).

(Sequence S316) Then, at the IP telephone 200, when the user operates the operating unit 40 and indicates an intention that the user will make a response to the incoming call, the control unit 70 detecting the intention controls the communication unit 10 to send the 200 OK message to the SIP server 300.

(Sequence S317) When the SIP server 300 receives the 200 OK message, the SIP server 300 sends the 200 OK message having the same contents as the received message to the IP telephone 100 serving as the terminal of the outgoing side.

(Sequence S318) At the IP telephone 100, when the control unit 70 detects that the communication unit 10 has received the 200 OK message, the control unit 70 displays the fact that the response has come, and controls the communication unit 10 to send ACK message indicating that the communication unit 10 has received the 200 OK message to the SIP server 300.

(Sequence S319) When the SIP server 300 receives the ACK message, the SIP server 300 sends the ACK message having the same contents as the received message to the IP telephone 200 serving as the terminal of the incoming side.

(Sequence S320) When the IP telephone 200 receives the ACK message, the IP communication link between the IP telephone 100 and the IP telephone 200 via the SIP server 300 is established. After that, speech data (or video data) are exchanged over the IP communication link between the IP telephone 100 and the IP telephone 200, and telephone conversation is thereby implemented.

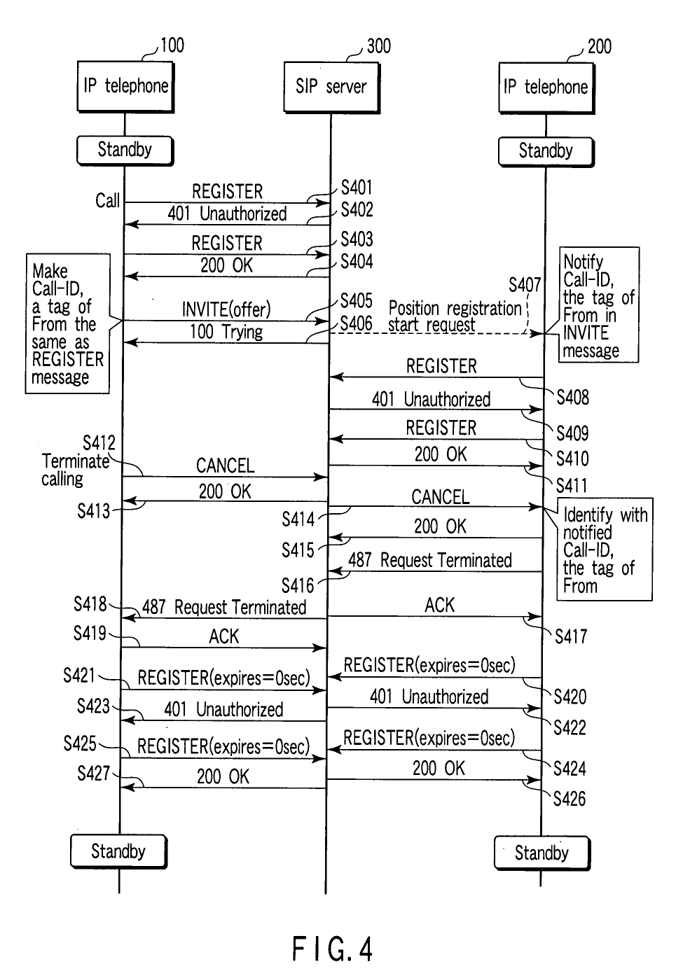

Next, operations of terminating the outgoing call of the IP telephone 100 after the outgoing call of the IP telephone 100 and before the establishment of an IP communication link, in the case where the IP telephone 100 is the outgoing side and the IP telephone 200 is the incoming side similarly to FIG. 3, are described. A sequence of the operations is shown in FIG. 4.

First, the IP telephone 100 and the IP telephone 200 in the standby status are not connected to the IP network and their existence is not recognized by the SIP server 300.

(Sequence S401) At the IP telephone 100, when the user operates the operating unit 40, inputs the dial number of the IP telephone 200 and makes an outgoing call request, the control unit 70 controls the communication unit 10 to connect to the packet network, send the REGISTER request message to the SIP server 300 and start the position registration.

(Sequence S402) When the SIP server 300 receives the REGISTER request message, the SIP server 300 sends the 401 Unauthorized message to the IP telephone 100 as a response (REGISTER response) to the REGISTER request message.

(Sequence S403) At the IP telephone 100, when the control unit 70 detects that the communication unit 10 has received the 401 Unauthorized message, the control unit 70 controls the communication unit 10 to send the REGISTER request message to the SIP server 300, again, after server authentication.

(Sequence S404) When the SIP server 300 receives the REGISTER request message, the SIP server 300 sends the 200 OK message to the IP telephone 100 as a response (REGISTER response) to the REGISTER request message.

(Sequence S405) At the IP telephone 100, when the control unit 70 detects that the communication unit 10 has received the 200 OK message, the control unit 70 generates authentication information which includes identification information and codec ability information of the IP telephone 100 and identification information of the IP telephone 200 serving as the call destination (incoming terminal) as destination information, on the basis of the information stored in the memory unit 60.

The control unit 70 generates the INVITE request message including these information items and controls the communication unit 10 to send the generated INVITE request message to the SIP server 300. Thus, the IP telephone 100 makes the call request for the SIP server 300 by sending the INVITE request message.

In the INVITE request message, the same Call-ID header field as the REGISTER request message sent in sequence S401, S403, and the tag parameter of From header field are described.

(Sequence S406) When the SIP server 300 receives the INVITE request message, the SIP server 300 sends the 100 Trying message to the IP telephone 100 as a response (INVITE response) to the INVITE request message. At the IP telephone 100, when the control unit 70 detects that the communication unit 10 has received the 100 Trying message, the control unit 70 becomes in the standby status.

(Sequence S407) The SIP server 300 specifies the incoming terminal as the IP telephone 200 on the basis of the destination information included in the INVITE request message, and specifies the radio base station BS with which the IP telephone 200 can make communication on the basis of the position registration information in the mobile communication network.

Then, the SIP server 300 makes the position registration request to urge the IP telephone 200 to connect to the IP network with an existing communication protocol other than the SIP by the communication means other than the IP network such as the circuit switched network, short-range communication means, etc. In the position registration request, the Call-ID header field and the tag parameter of From header field described in the INVITE request message received in sequence S405 are described.

(Sequence S408) At the IP telephone 200, when the control unit 70 detects that the communication unit 10 has received the position registration request, the control unit 70 controls the communication unit 10 to send the REGISTER request message to the SIP server 300.

(Sequence S409) When the SIP server 300 receives the REGISTER request message, the SIP server 300 sends the 401 Unauthorized message to the IP telephone 200 as a response (REGISTER response) to the REGISTER request message.

(Sequence S410) At the IP telephone 200, when the control unit 70 detects that the communication unit 10 has received the 401 Unauthorized message, the control unit 70 controls the communication unit 10 to send the REGISTER request message to the SIP server 300, again, after server authentication.

(Sequence S411) When the SIP server 300 receives the REGISTER request message, the SIP server 300 sends the 200 OK message to the IP telephone 200 as a response (REGISTER response) to the REGISTER request message. The position registration concerning the IP communication at the IP telephone 200 is thereby completed. At this time, the IP telephone 200 establishes and maintains an IP communication link with the nearest radio base station BS.

(Sequence S412) At the IP telephone 100, when the user makes a request for terminating the outgoing call by operating an on-hook key of the operating unit 40, the control unit 70 detecting the request generates CANCEL request message and controls the communication unit 10 to send the CANCEL request message to the SIP server 300.

(Sequence S413) When the SIP server 300 receives the CANCEL request message, the SIP server 300 sends the 200 OK message to the IP telephone 100 as a response (CANCEL response) to the received CANCEL request message.

(Sequence S414) By receiving the CANCEL request message from the IP telephone 100, the SIP server 300 forms a CANCEL request message describing the Call-ID header field and the tag parameter of From header field of which the SIP server 300 has notified the IP telephone 200 at the position registration request in the sequence S407, and controls the communication unit 10 to send the CANCEL request message to the IP telephone 200.

(Sequence S415) At the IP telephone 200, the communication unit 10 receives the CANCEL request message. At the IP telephone 200, the control unit 70 detects that the Call-ID header field and the tag parameter of From header field described in the CANCEL request message match the Call-ID header field and the tag parameter of From header field described in the position registration request in the sequence S407.

Thus, the control unit 70 recognizes that the outgoing call to be made subsequently to the position registration in sequence S407 to S411 has been canceled, and sends the 200 OK message to the SIP server 300 as a response (CANCEL response) to the CANCEL request message.

(Sequence S416) At the IP telephone 200, the control unit 70 forms 487 Request Terminated message and controls the communication unit 10 to send the 487 Request Terminated message to the SIP server 300.

(Sequence S417) When the SIP server 300 receives the 487 Request Terminated message, the SIP server 300 sends the ACK message to the IP telephone 200.

(Sequence S418) In addition, the SIP server 300 sends the 487 Request Terminated message to the IP telephone 100 which has sent the CANCEL request message in the sequence S412.

(Sequence S419) At the IP telephone 100, when the control unit 70 detects that the communication unit 10 has received the 487 Request Terminated message, the control unit 70 controls the communication unit 10 to send the ACK message to the SIP server 300.

(Sequence S420) At the IP telephone terminal 200, the control unit 70 forms REGISTER request message whose expiration period (expires) is 0 sec and controls the communication unit 10 to send the formed REGISTER request message to the SIP server 300.

(Sequence S421) Similarly, at the IP telephone 100, the control unit 70 forms REGISTER request message whose expiration period (expires) is 0 sec and controls the communication unit 10 to send the formed REGISTER request message to the SIP server 300.

(Sequence S422) The SIP server 300 sends the 401 Unauthorized message to the IP telephone 200 as a response (REGISTER response) to the REGISTER request message which the SIP server 300 has received from the IP telephone 200.

(Sequence S423) The SIP server 300 sends the 401 Unauthorized message to the IP telephone 100 as a response (REGISTER response) to the REGISTER request message which the SIP server 300 has received from the IP telephone 100.

(Sequence S424) At the IP telephone 200, the control unit 70 forms the REGISTER request message whose expiration period (expires) is 0 sec and controls the communication unit 10 to send the formed REGISTER request message to the SIP server 300, again, after server authentication.

(Sequence S425) Similarly, at the IP telephone 100, the control unit 70 forms the REGISTER request message whose expiration period (expires) is 0 sec and controls the communication unit 10 to send the formed REGISTER request message to the SIP server 300, again, after server authentication.

(Sequence S426) The SIP server 300 sends the 200 OK message to the IP telephone 200 as a response (REGISTER response) to the second REGISTER request message which the SIP server 300 has received from the IP telephone 200.

(Sequence S427) Similarly, the SIP server 300 sends the 200 OK message to the IP telephone 100 as a response (REGISTER response) to the second REGISTER request message which the SIP server 300 has received from the IP telephone 100. After that, the IP communication links of the IP telephone 100 and the IP telephone 200 with the radio base stations BS are disconnected and the IP telephone 100 and the IP telephone 200 become in the standby status.

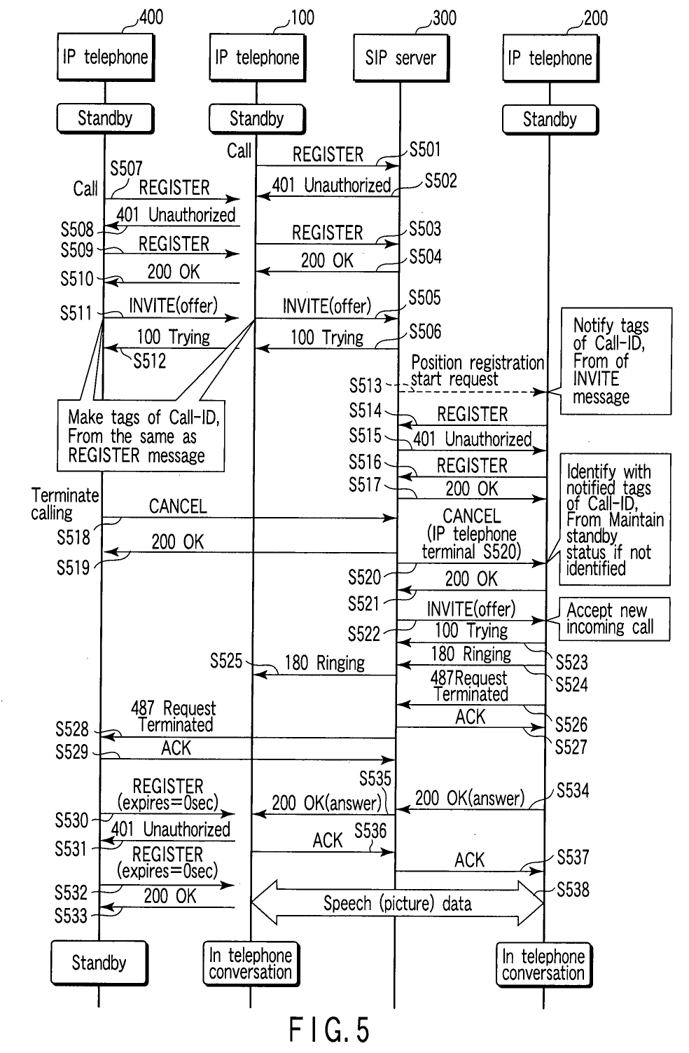

Next, operations of terminating the outgoing call of an IP telephone 400 after the outgoing call of the IP telephone 100 and the IP telephone 400 and before the establishment of an IP communication link, in the case where the IP telephone 100 is the outgoing side and the IP telephone 200 is the incoming side similarly to FIG. 3, are described. A sequence of the operations is shown in FIG. 5. The IP telephone 400 has the same configuration as the IP telephone 100.

First, the IP telephones 100, 400 and the IP telephone 200 in the standby status are not connected to the IP network and their existence is not recognized by the SIP server 300.

(Sequence S501) At the IP telephone 100, when the user operates the operating unit 40, inputs the dial number of the IP telephone 200 and makes an outgoing call request, the control unit 70 controls the communication unit 10 to connect to the packet network, send the REGISTER request message to the SIP server 300 and start the position registration.

(Sequence 502) When the SIP server 300 receives the REGISTER request message, the SIP server 300 sends the 401 Unauthorized message to the IP telephone 100 as a response (REGISTER response) to the REGISTER request message.

(Sequence S503) At the IP telephone 100, when the control unit 70 detects that the communication unit 10 has received the 401 Unauthorized message, the control unit 70 controls the communication unit 10 to send the REGISTER request message to the SIP server 300 again after server authentication.

(Sequence S504) When the SIP server 300 receives the REGISTER request message, the SIP server 300 sends the 200 OK message to the IP telephone 100 as a response (REGISTER response) to the REGISTER request message.

(Sequence S505) At the IP telephone 100, when the control unit 70 detects that the communication unit 10 has received the 200 OK message, the control unit 70 generates authentication information which includes identification information and codec ability information of the IP telephone 100 and identification information of the IP telephone 200 serving as the call destination (incoming terminal) as destination information, on the basis of the information stored in the memory unit 60.

The control unit 70 generates the INVITE request message including these information items and controls the communication unit 10 to send the generated INVITE request message to the SIP server 300. Thus, the IP telephone terminal 100 makes the call request for the SIP server 300 by sending the INVITE request message.

In the INVITE request message, the same Call-ID header field and the tag parameter of From header field as the REGISTER request message sent in sequence S501, S503 are described.

(Sequence S506) When the SIP server 300 receives the INVITE request message, the SIP server 300 sends the 100 Trying message to the IP telephone 100 as a response (REGISTER response) to the INVITE request message. At the IP telephone 100, when the control unit 70 detects that the communication unit 10 has received the 100 Trying message, the control unit 70 becomes in the standby status.

(Sequence S507) At the IP telephone 400, too, the user operates the operating unit 40 to input the dial number of the IP telephone 200 and make an outgoing call request. The control unit 70 thereby controls the communication unit 10 to connect to the packet network, send the REGISTER request message to the SIP server 300 and start the position registration.

(Sequence S508) When the SIP server 300 receives the REGISTER request message, the SIP server 300 sends the 401 Unauthorized message to the IP telephone 400 as a response (REGISTER response) to the REGISTER request message.

(Sequence S509) At the IP telephone 400, when the control unit 70 detects that the communication unit 10 has received the 401 Unauthorized message, the control unit 70 controls the communication unit 10 to send the REGISTER request message to the SIP server 300, again, after server authentication.

(Sequence S510) When the SIP server 300 receives the REGISTER request message, the SIP server 300 sends the 200 OK message to the IP telephone 400 as a response (REGISTER response) to the REGISTER request message.

(Sequence S511) At the IP telephone 400, when the control unit 70 detects that the communication unit 10 has received the 200 OK message, the control unit 70 generates authentication information which includes identification information and codec ability information of the IP telephone 400 and identification information of the IP telephone 200 serving as the call destination (incoming terminal) as destination information, on the basis of the information stored in the memory unit 60.

The control unit 70 generates the INVITE request message including these information items and controls the communication unit 10 to send the generated INVITE request message to the SIP server 300. Thus, the IP telephone 400 makes the call request for the SIP server 300 by sending the INVITE request message.

In the INVITE request message, the same Call-ID header field as the REGISTER request message sent in sequence S507, S509, and the tag parameter of From header field are described.

(Sequence S512) When the SIP server 300 receives the INVITE request message, the SIP server 300 sends the 100 Trying message to the IP telephone 400 as a response (INVITE response) to the INVITE request message. At the IP telephone 400, when the control unit 70 detects that the communication unit 10 has received the 100 Trying message, the control unit 70 becomes in the standby status.

(Sequence S513) The SIP server 300 specifies the incoming call terminal as the IP telephone 200 on the basis of the destination information included in the INVITE request message of sequence S505 and S511, and specifies the radio base station BS with which the IP telephone 200 can make communication on the basis of the position registration information in the mobile communication network.

Then, the SIP server 300 makes the position registration request to urge the IP telephone 200 to connect to the IP network with an existing communication protocol other than the SIP by the communication means other than the IP network such as the circuit switched network, short-range communication means, etc. In the position registration request, the Call-ID header field and the tag parameter of From header field described in the INVITE request message received in sequence S505 and S511 are described.

(Sequence S514) At the IP telephone 200, when the control unit 70 detects that the communication unit 10 has received the position registration request, the control unit 70 controls the communication unit 10 to send the REGISTER request message to the SIP server 300.

(Sequence S515) When the SIP server 300 receives the REGISTER request message, the SIP server 300 sends the 401 Unauthorized message to the IP telephone 200 as a response (REGISTER response) to the REGISTER request message.

(Sequence S516) At the IP telephone 200, when the control unit 70 detects that the communication unit 10 has received the 401 Unauthorized message, the control unit 70 controls the communication unit 10 to send the REGISTER request message to the SIP server 300, again, after server authentication.

(Sequence S517) When the SIP server 300 receives the REGISTER request message, the SIP server 300 sends the 200 OK message to the IP telephone 200 as a response (REGISTER response) to the REGISTER request message. The position registration concerning the IP communication at the IP telephone 200 is thereby completed. At this time, the IP telephone 200 establishes and maintains an IP communication link with the nearest radio base station BS.

(Sequence S518) At the IP telephone 400, when the user makes a request for terminating the outgoing call by operating an on-hook key of the operating unit 40, the control unit 70 detecting the request generates the CANCEL request message and controls the communication unit 10 to send the CANCEL request message to the SIP server 300.

(Sequence S519) When the SIP server 300 receives the CANCEL request message, the SIP server 300 sends the 200 OK message to the IP telephone 400 as a response (CANCEL response) to the received CANCEL request message.

(Sequence S520) By receiving the CANCEL request message from the IP telephone 400, the SIP server 300 forms a CANCEL request message describing the Call-ID header field and the tag parameter of From header field of which the SIP server 300 has notified the IP telephone 400 at the position registration request in the sequence S513, and controls the communication unit 10 to send the CANCEL request message to the IP telephone 200.

(Sequence S521) At the IP telephone 200, the communication unit 10 receives the CANCEL request message. At the IP telephone 200, the control unit 70 detects that the Call-ID header field and the tag parameter of From header field described in the CANCEL request message match the Call-ID header field and the tag parameter of From header field described in the position registration request in the sequence S513.

Thus, the control unit 70 recognizes that the outgoing call of the IP telephone 400 to be made subsequently to the position registration in sequence S507 to S510 has been canceled, and sends the 200 OK message to the SIP server 300 as a response (CANCEL response) to the CANCEL request message.

(Sequence S522) The SIP server 300 sends the INVITE request message of the IP telephone 100 received in sequence S505 to the IP telephone 200.

(Sequence S523) At the IP telephone 200, when the control unit 70 detects that the communication unit 10 has received the INVITE request message, the control unit 70 sends the 100 Trying message to the SIP server 300 as a response to the INVITE request message.

(Sequence S524) In addition, at the IP telephone 200, when the control unit 70 detects that the communication unit 10 has received the 100 Trying message, the control unit 70 displays the telephone number of the outgoing terminal (IP telephone 100) notified in sequence S522 on the display unit 30 and controls the notifying unit 50 to notify the user of the occurrence of the incoming call. In addition, the control unit 70 controls the communication unit 10 to send 180 Ringing message to the SIP server 300.

(Sequence S525) When the SIP server 300 receives the 180 Ringing message, the SIP server 300 sends the 180 Ringing message of the same contents as the received message to the IP telephone 100. At the IP telephone 100 receiving the 180 Ringing message, the control unit 70 controls the speech processor 20 to output a ringback tone from the speaker 21 and notify the user of calling the incoming terminal (IP telephone 200).

(Sequence S526) At the IP telephone 200, the control unit 70 generates the 487 Request Terminated message for the IP telephone 400 and controls the communication unit 10 to send the 487 Request Terminated message to the SIP server 300.

(Sequence S527) When the SIP server 300 receives the 487 Request Terminated message, the SIP server 300 sends the ACK message to the IP telephone 200.

(Sequence S528) In addition, the SIP server 300 sends the 487 Request Terminated message to the IP telephone 400 which has sent the CANCEL request message in the sequence S512.

(Sequence S529) At the IP telephone 400, when the control unit 70 detects that the communication unit 10 has received the 487 Request Terminated message, the control unit 70 controls the communication unit 10 to send the ACK message to the SIP server 300.

(Sequence S530) At the IP telephone 400, the control unit 70 generates the REGISTER request message whose expiration period (expires) is 0 sec and controls the communication unit 10 to send the generated REGISTER request message to the SIP server 300.

(Sequence S531) The SIP server 300 sends the 401 Unauthorized message to the IP telephone 400 as a response (REGISTER response) to the REGISTER request message which the SIP server 300 has received from the IP telephone 400.

(Sequence S532) At the IP telephone 400, the control unit 70 generates the REGISTER request message whose expiration period (expires) is 0 sec and controls the communication unit 10 to send the formed REGISTER request message to the SIP server 300, again, after server authentication.

(Sequence S533) The SIP server 300 sends the 200 OK message to the IP telephone 200 as a response (REGISTER response) to the second REGISTER request message which the SIP server 300 has received from the IP telephone 400.

(Sequence S534) Then, at the IP telephone 200, when the user operates the operating unit 40 and indicates an intention that the user will make a response to the incoming call, the control unit 70 detecting the intention controls the communication unit 10 to send the 200 OK message to the SIP server 300.

(Sequence S535) When the SIP server 300 receives the 200 OK message, the SIP server 300 sends the 200 OK message having the same contents as the received message to the IP telephone 100 serving as the terminal of the outgoing side.

(Sequence S536) At the IP telephone 100, when the control unit 70 detects that the communication unit 10 has received the 200 OK message, the control unit 70 displays the fact that the response has come, and controls the communication unit 10 to send the ACK message indicating that the communication unit 10 has received the 200 OK message to the SIP server 300.

(Sequence S537) When the SIP server 300 receives the ACK message, the SIP server 300 sends the ACK message having the same contents as the received message to the IP telephone 200 serving as the terminal of the incoming side.

(Sequence S538) When the IP telephone 200 receives the ACK message, the IP communication link between the IP telephone 100 and the IP telephone 200 via the SIP server 300 is established. After that, speech data (or video data) are exchanged over the IP communication link between the IP telephone 100 and the IP telephone 200, and telephone conversation is thereby implemented.

As described above, if the mobile radio terminal having the above configuration functions as the IP telephones 100, 400 of the outgoing call side, the mobile radio terminal notifies the IP telephone 200 of the incoming call side of the identification information of the own terminals 100, 400 upon making the request for start of the position registration (sequence S307, S407, S513). If the user makes the request for termination of the outgoing call before establishment of the IP communication link with the IP telephone 200 of the incoming call side, the IP telephone 100, 400 of the outgoing call side notifies the IP telephone 200 of the incoming call side of the termination request indicating the termination of the outgoing call, together with the identification information of the own terminals 100, 400.

In addition, if the mobile radio terminal having the above configuration functions as the IP telephone 200 of the incoming call side, the IP telephone 200 receives the position registration request from the SIP server 300 which has specified the position on the basis of the position registration information, and establishes the IP communication link with the SIP server 300 via the radio base station BS in accordance with the request. After that, when the IP telephone 200 receives the notification of termination request before the IP communication link with the IP telephone of the outgoing call side is established, the IP telephone 200 disconnects the IP communication link established with the radio base stations BS and becomes in the standby status if there is a single outgoing call terminal as shown in FIG. 4, or does not disconnect but maintains the IP communication links established with the radio base stations BS if there are a plurality of outgoing call terminals and the IP telephone terminal 200 does not accept the termination request from any one of the outgoing call terminals as shown in FIG. 5.

Thus, when the IP telephones 100, 400 of the outgoing call side cancels the outgoing call, IP telephone disconnects the unnecessary IP communication link. Therefore, an unnecessary access of the IP telephone 200 of the incoming call side to the IP network can be prevented. In addition, if a plurality of IP telephones of the outgoing call side exist, the IP communication link of the IP telephone 200 of the incoming call side can be maintained unless all the outgoing call terminals make the termination request.

The present invention is not limited to the embodiments described above but the constituent elements of the invention can be modified in various manners. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio terminal having a function of making radio communication with a base station accommodated in a mobile radio network and executing data communication based on IP communication, the terminal comprising:
a radio interface which communicates with the base station and receives identification information of a terminal of an outgoing call side from the radio base station;
a link establishing unit which establishes an IP communication link via the radio base station if the radio interface receives the identification information of the terminal of the outgoing call side;
an IP communication unit which makes data communication over the IP communication link; and
a disconnection unit which disconnects the IP communication link if the radio interface receives again identification information which matches the identification information of a terminal of an outgoing call side, together with information of canceling the outgoing call before the IP communication unit makes the data communication.

2. The terminal according to claim 1, wherein the radio interface further receives instruction information urging the mobile radio terminal to establish the IP communication link.

3. The terminal according to claim 1, further comprising short-range communication means, wherein the identification information is received via the short-range communication means.

4. The terminal according to claim 3, wherein the short-range communication means further receives instruction information urging the mobile radio station to establish the IP communication link.

5. A mobile radio terminal having a function of making radio communication with a base station accommodated in a mobile radio network and executing data communication based on IP communication, the terminal comprising:
a radio interface which communicates with the base station and receives identification information of a terminal of an outgoing call side from the base station;
a link establishing unit which establishes an IP communication link via the base station if the radio interface receives the identification information of the terminal of the outgoing call side;
an IP communication unit which makes data communication over the IP communication link; and
a disconnection unit which disconnects the IP communication link if the radio interface receives again identification information which matches the identification information of a terminal of an outgoing call side, together with information of canceling the outgoing call before the IP communication unit makes the data communication,
the disconnection unit disconnecting the IP communication link only if the radio interface receives again all of identification information items that match the plurality of different identification information items, together with information of canceling the outgoing call, before the IP communication unit makes the data communication, in a case where the radio interface receives a plurality of different identification information items before the establishment of the IP communication link and the link establishing unit establishes the IP communication link.

6. The terminal according to claim 5, wherein the radio interface further receives instruction information urging the mobile radio terminal to establish the IP communication link.

7. The terminal according to claim 5, further comprising short-range communication means, wherein the identification information is received via the short-range communication means.

8. The terminal according to claim 7, wherein the short-range communication means further receives instruction information urging the mobile radio station to establish the IP communication link.

9. A mobile telephone connectable to a base station via a radio link, comprising:
radio communication means for communicating with the base station;
detecting means for detecting identification information transmitted from a caller terminal via the radio communication means;
connection control means for controlling a communication link with the base station via the radio communication means;
wherein the connection control means establishes an IP communication link with the base station if the detecting means detects the identification information, and disconnects the established IP communication link if identification information which matches the identification information before establishing the IP communication link, is received together with a canceling request.

10. The mobile telephone according to claim 9, wherein the detecting means further detects instruction information urging the mobile telephone to establish the IP communication link, and the connection control means establishes the IP communication link with the base station if the detecting means detects the instruction information.

11. The mobile telephone according to claim 9, further comprising short-range communication means, wherein the identification information is received via the short-range communication means.

12. The mobile telephone according to claim 11, wherein the short-range communication means further receives instruction information urging the mobile telephone to establish the IP communication link.
